(19) United States
(12) Patent Application Publication
(10) Pub. No.: US 2025/0047036 A1
(43) Pub. Date: Feb. 6, 2025

(54) COUPLING FOR TWO PLUG-IN CONNECTORS

(71) Applicant: Robert Bosch GmbH, Stuttgart (DE)

(72) Inventor: Rolf Wittmann, Ubstadt-Weiher (DE)

(21) Appl. No.: 18/710,845

(22) PCT Filed: Nov. 8, 2022
(86) PCT No.: PCT/EP2022/081108

§ 371 Date: May 16, 2024

(30) Foreign Application Priority Data
Nov. 8, 2021 (DE) 10 1021 212 541.7

(51) Int. Cl. H01R 13/631; H01R 13/50

(52) U.S. Cl. CPC H01R 13/631; H01R 13/50; H01R 2201/26

(57) ABSTRACT

A coupling for receiving two plug-in connectors which face one another. The coupling has a sleeve-like housing which extends along an axial direction and has a first end, a second end averted from the first end, and an interior space. A first opening for inserting a first plug-in connector having a first faster is at the first end. A second opening for inserting a second plug-in connector having a second fastener is at the second end. A first coupling fastener is arranged at the first end and interacts with the first fastener of the first plug-in connector in such a way that the first plug-in connector is captively coupled to the coupling. A second coupling fastener is arranged at the second end, and interacts with the second fastener of the second plug-in connector in such a way that the second plug-in connector is captively coupled to the coupling.

### FIELD

The present invention relates to a coupling which is designed for receiving two plug-in connectors which face one another, make direct electrical contact with one another and each have at least one fastening means for fastening to a mating plug-in connector. It furthermore relates to a plug-in connector arrangement with such a coupling and with a first plug-in connector and a second plug-in connector.

### BACKGROUND INFORMATION

Various cable harnesses for motor vehicles are described in the related art. These cable harnesses can have a plug-in connector or a cable harness plug at one end, which has a housing with contact chambers, wherein contact elements are fitted in the contact chambers. Some or all of these contact elements can be designed as female contact elements, for example as socket contact elements. The plug-in connector can be connected to a mating plug-in connector, for example to an interface of a control device. The mating plug-in connector has mating contact elements, which are designed to be complementary to the contact elements of the plug-in connector. If a female contact element is provided on the side of the plug-in connector, a male contact element is provided on the side of the mating plug-in connector, for example a contact blade or a contact pin.

Such a wiring harness plug or plug-in connector is described in German Patent Application No. DE 10 2004 030 991 A1.

Furthermore, conventional plug-in connectors often also have at least one fastening means in order to be captively mechanically coupled to the complementary mating plug-in connector. This is important for plug-in connectors in motor vehicles, for example, so that the electrical connection is not accidentally disconnected. Furthermore, plug-in connectors with a high number of contact elements (for example more than five contact elements or more than ten contact elements or more than 50 contact elements) are described in the related art. In order to minimize the operating efforts of a fitter when plugging together the plug-in connector and mating plug-in connector, even with a large number of contact elements, transmission mechanisms can be provided, for example in the form of lever elements and/or sliding elements. These elements have a fastening means, for example in the form of a sliding track or a toothed wheel. When plugged together, these fastening means then interact with corresponding mating plug-in connector fastening means, for example in the form of a bolt, pin or projection or in the form of a toothed rack. In this way, for example, the plug-in connector can be connected to the mating plug-in connector, for example a male connector of a control device, by means of a suitable lever design and/or design of the sliding track with low operating effort. At the same time, the fastening means can achieve, in their end position, a captive coupling between the plug-in connector and mating plug-in connector.

German Patent Application No. DE 10 2013 212 914 A1 describes a plug-in connector that has a fastening means in the form of a lever element with a single-toothed wheel that meshes with a mating plug-in connector fastening means in the form of a toothed rack. In the fully plugged-together state, the plug-in connector and mating plug-in connector are captively coupled to one another through the interaction of the fastening means and the mating plug-in connector fastening means.

German Patent Application No. DE 195 11 225 A1 describes a plug-in connector that has a fastening means in the form of a sliding element with a plurality of sliding tracks, wherein the sliding tracks interact with pins or bolts or projections as mating plug-in connector fastening means. In the fully plugged-together state, the plug-in connector and mating plug-in connector are captively coupled to one another through the interaction of the fastening means and the mating plug-in connector fastening means.

German Patent Application No. DE 10 2005 047 349 A1 describes a plug-in connector that has a lever element as a fastening means, which has two sliding tracks that interact with pins as mating plug-in connector fastening means.

German Patent No. DE 297 02 999 U1 describes a plug-in connector that has a sliding element with a toothed rack and a toothed wheel as fastening means, wherein the toothed rack meshes with the toothed wheel, wherein the toothed wheel meshes with a further toothed rack on its side averted from the toothed rack, which serves as a mating plug-in connector fastening means. Female contact elements of the plug-in connector are pushed onto male contact elements of the mating plug-in connector when they are plugged together.

### SUMMARY

The present invention is based on the realization that there may be situations in which the plug-in connector or the cable harness plug is to be plugged together with a mating plug-in connector which has at least one female contact element, such that in this case a female contact element of the plug-in connector meets a female contact element of the mating plug-in connector. Such a situation can occur, for example, if two cable harness plugs of the same type are to be coupled to one another, for example to extend a section of cable harness. Other applications can be mating interfaces that have been converted from male contact elements to female contact elements. Electrical contacting is not readily possible in such cases. In these cases, it is necessary to fit the plug-in connector with male contact elements (or at least one male contact element), which can then be plugged together with the corresponding female contact elements of the mating plug-in connector and are thus electrically contacted.

Such plug-in connectors which have to be fitted with male contact elements are only required in relatively small quantities in motor vehicles, for example, since most control devices and other components usually have a male connector with male contact elements as an electrical interface or provide individual male contact elements for contacting.

It has been shown that the production of mating plug-in connector housings (for example, for the purpose of an extension cable described above) which are fitted with the complementary contact elements to the plug-in connector (i.e., usually with male contact elements) is expensive. This is because a specially manufactured tool is required to produce these mating plug-in connector housings, which are only needed in small quantities, with the corresponding mating plug-in connector fastening means (i.e., fastener), such that the plug-in connector can be captively coupled with such mating plug-in connector housings.

Therefore, there may be a need to provide a cost-effective way of mechanically coupling two such plug-in connectors that cannot be directly mechanically coupled to one another. Furthermore, there may be a need to provide one of two such plug-in connectors in a simple manner for mechanical coupling as a kind of mating plug-in connector, for example as one end of an extension line that is coupled to the other plug-in connector. Therefore, there may be a need to securely and reliably couple two such plug-in connectors, which are formed to be cost-effective and cannot easily be coupled to one another, electrically and mechanically, in particular captively. Furthermore, there may be a need to form a direct electrical connection between the two plug-in connectors, without intermediate electrical conductors, in order to save installation space and avoid multiple contact transitions as far as possible, since these each have a contact resistance and pose a risk of contact interruption. In other words, intermediate adapter pieces that are longer in their longitudinal extension and may still have conductors inside them should not be used.

This need can be met by features of the present invention. Advantageous embodiments of the present invention are disclosed herein.

According to a first aspect of the present invention, a coupling is provided.

According to an example embodiment of the present invention, the coupling is designed for receiving two plug-in connectors which face one another, make direct electrical contact with one another and each have at least one fastening means for fastening to a mating plug-in connector. The coupling has a housing that extends along an axial direction.

The housing has a first end and a second end averted from said first end. Furthermore, the coupling has an interior space. The interior space can be an interior space of the housing, for example. A first opening is provided at the first end of the housing for inserting a first plug-in connector, which has a first fastening means. The first opening can also be designed for inserting the first plug-in connector. A second opening is provided at the second end of the housing for inserting a second plug-in connector, which has a second fastening means. The second opening can also be designed for inserting the second plug-in connector. A first coupling fastening means is arranged at the first end. This is designed to interact with the first fastening means of the first plug-in connector in such a way that the first plug-in connector can be captively coupled to the coupling or is captively coupled if the first plug-in connector is inserted into the coupling in its intended position or is coupled to the coupling in its intended position. A second coupling fastening means is arranged at the second end. This is designed to interact with the second fastening means of the second plug-in connector in such a way that the second plug-in connector can be captively coupled to the coupling or is captively coupled if the second plug-in connector is inserted into the coupling in its intended position or is coupled to the coupling in its intended position.

As a result, a very simple and cost-effective apparatus is created, by means of which two plug-in connectors can be securely, reliably and permanently coupled to one another, even if their fastening means or their fastening elements do not enable direct coupling with one another (for example, because the fastening elements or fastening means of the two plug-in connectors to be coupled to one another are both formed, for example, as a lever element or both formed as a sliding element (hereinafter referred to as female type) or both formed as a pin, projection, bolt, toothed rack (all hereinafter referred to as male type) for interaction with a lever element or a sliding element). The captive coupling of the two plug-in connectors to one another is thus achieved indirectly by the coupling providing the two coupling fastening means, by means of which one of the plug-in connectors can be captively coupled to the coupling (in the example case, the coupling would then have two male coupling fastening means complementary to the female-type fastening means of the plug-in connectors or vice versa, although mixed forms are also possible-one coupling fastening means is of the female type, the other of the male type). As a result, the coupling advantageously provides an apparatus or component that enables a significant cost reduction for the provision of the applications described above (for example, extension cables for cable harnesses or with multi-pole connectors).

This is because the coupling makes it advantageously possible, for example, to form the matching counterpart, i.e. the second plug-in connector, with the same (first) plug-in connector housing for connecting a conventional (first) plug-in connector and then to fit this second plug-in connector only with contact elements that are complementary to those of the first plug-in connector. However, it is not necessary to produce a completely new housing for the second plug-in connector, for example with a second fastening means complementary to the first plug-in connector. In other words, the coupling makes it possible to reduce the costs of the second plug-in connector for such extension lines, which is only required in small quantities and is expensive to produce, by having the coupling take over the mechanical interface functions. The coupling acts, for example, like a kind of adapter, but preferably without an electrical function and/or without electrical conductors. It can be designed in such a way that it only provides the mechanical mating interfaces for the plug-in connectors by means of its housing and enables direct contact between the two plug-in connectors in its interior space.

A radial direction runs perpendicularly to the axial direction. A direction of rotation extends around the axial direction.

The coupling itself can be produced very simply and cost-effectively, for example from an insulating plastics material. It can be produced by injection molding, for example. In principle, however, it can be made of a (metal) sheet or another material with good electrical conductivity. In this case, the coupling can also advantageously achieve a shielding effect with respect to the electrical connection which is formed in the interior space of the inserted plug-in connectors. Furthermore, it is possible to design the coupling as a connecting component. For example, it can be partially made of plastics material, which enables electrical insulation (for example, in the region of the direct electrical contact between the two plug-in connectors). Furthermore, it can be partially made of metal, for example in order to provide shielding.

According to an example embodiment of the present invention, the housing can, for example, be formed like a sleeve. For example, it can have a first plug-in collar at the first end. The first coupling fastening means can be attached to or arranged on the first plug-in collar. The shape of the first plug-in collar can be analogous to the plug-in collar or the plug-in interface of the mating plug-in connector corresponding to the first plug-in connector. As a result, the first plug-in connector can be easily captively coupled to the coupling at the first end. The housing can, for example, have a second plug-in collar at the second end. The second coupling fastening means can be attached to or arranged on the second plug-in collar. The shape of the second plug-in collar can be analogous to the plug-in collar or the plug-in interface of the mating plug-ion connector corresponding to the second plug-in connector. As a result, the second plug-in connector can be easily captively coupled to the coupling at the second end.

It is understood that the coupling can have a single first coupling fastening means or a single second coupling fastening means. However, it can also have a plurality of, for example two, three, four or even more, first and/or second coupling fastening means. If multiple first and/or second coupling fastening means is provided, these can all be of the same design or differ from one another, for example in order to interact with different first and/or second fastening means of the first or second plug-in connector. They can also achieve different holding functions (radial, axial, etc.), such that a separation of functions can arise.

For example, the first opening and the second opening can in each case be aligned parallel to the axial direction, averted from one another. However, it is also possible that the openings are arranged at an angle to one another, as long as a direct connection between the contact elements arranged in the two plug-in connectors is enabled.

It can be particularly advantageously provided that the captive coupling can be released again non-destructively.

Within the scope of this application, the term “having” is used synonymously with the term “comprising,” unless otherwise described.

In a further development of the present invention, the housing is torsionally stiff and/or rigid. In other words, the housing is not merely a resilient silicone sleeve, for example, or a sheathing of a connection between the two plug-in connectors with an insulating tape or the like.

As a result, it is advantageously achieved that the first and/or second plug-in connector can be coupled to the coupling in a particularly secure and captive manner. Furthermore, in a state in which the two plug-in connectors are coupled with the coupling, the electrical connection point or contacting point between the two plug-in connectors is protected particularly securely, for example against external mechanical influences.

In a further development of the present invention, the first coupling fastening means or coupling fastening element is designed to form a positive and/or non-positive and/or frictional connection to the first fastening means. As a result, a coupling between the coupling and the first plug-connector that is particularly simple and reliable to produce is advantageously enabled. Preferably, such a coupling can be released non-destructively, for example for maintenance purposes.

Alternatively or additionally, the second coupling fastening means or coupling fastening element can be designed to form a positive and/or non-positive and/or frictional connection to the second fastening means. As a result, a coupling between the coupling and the second plug-connector that is particularly simple and reliable to produce is advantageously enabled. Preferably, such a coupling can be released non-destructively, for example for maintenance purposes.

In a further development of the present invention, the first coupling fastening means is formed as an outwardly or inwardly projecting bolt or pin or projection. The first coupling fastening means can alternatively be formed as a toothed rack. The bolt or pin or projection or the toothed rack is/are designed to interact with a first fastening means formed as a lever element or as a sliding element for captive coupling between the coupling and the first plug-in connector.

“Projecting outwardly” can be understood to mean, for example, projecting in a radial direction away from the interior space, for example from an outer side of the housing into an exterior space of the coupling. “Projecting inwardly” can mean, for example, projecting radially inwardly into the interior space, for example starting from the inside of the housing.

It is understood that a plurality of the aforementioned elements (bolt, pin, projection, toothed rack) can also be provided acting together as coupling fastening means. Different first coupling fastening means can also be provided at different points on the first end.

Furthermore, it is understood that exactly one first coupling fastening means (for example, exactly one bolt, etc.) can be provided. However, a plurality of first coupling fastening means (for example, two, three, four or even more), for example bolts, etc., can also be provided. These can also be arranged on different sides of the housing or all on the same side.

As a result, a particularly simple and secure coupling between the first plug-in connector and the coupling is advantageously enabled. Furthermore, as a result, a low operating force when plugging together the first plug-in connector and the second plug-in connector can also advantageously be achieved, analogous to such a reduction in operating force when plugging together with the mating plug-in connector actually intended for the first plug-in connector (for example, a control device interface with a plug-in collar).

Alternatively or additionally, the second coupling fastening means is formed as a further outwardly or inwardly projecting bolt or further pin or further projection. The second coupling fastening means can alternatively be formed as a further toothed rack. The further bolt or further pin or further projection or the further toothed rack is/are designed to interact with a second fastening means formed as a further lever element or further sliding element for captive coupling between the coupling and the second plug-in connector.

It is understood that a plurality of the aforementioned elements (further bolt, further pin, further projection, further toothed rack) can also be provided acting together as coupling fastening means. Different second coupling fastening means can also be provided at different points on the second end.

Furthermore, it is understood that exactly one second coupling fastening means (for example, exactly one further bolt, etc.) can be provided. However, a plurality of second coupling fastening means (for example two, three, four or even more), for example further bolts, etc., can also be provided. These can also be arranged on different sides of the housing or all on the same side.

As a result, a particularly simple and secure coupling between the second plug-in connector and the coupling is advantageously enabled. Furthermore, as a result, a low operating force when plugging together the first plug-in connector and the second plug-in connector can also advantageously be achieved, analogous to such a reduction in operating force when plugging together with the mating plug-in connector actually intended for the second plug-in connector (for example, a control device interface with a plug-in collar).

In a further development of the present invention, a stop is provided in the interior space of the housing, wherein the stop is designed to block a displacement of the first plug-in connector and/or the second plug-in connector along their respective plug-in directions beyond the stop.

As a result, it is advantageously achieved that when the first plug-in connector and/or second plug-in connector is inserted, the first plug-in connector is reliably inserted to its correct position with respect to the axial direction and/or the second plug-in connector is also inserted to its correct axial position with respect to the axial direction. In this way, a secure and reliable electrical contact in the interior space of the coupling between the first plug-in connector and the second plug-in connector is ensured. Furthermore, as a result, the correct positioning of the plug-in connector fastening means with the associated coupling fastening means is ensured. Furthermore, through the stop, haptic feedback for a fitter that the correct position has been reached is achieved. The stop in the interior space can be designed to be movable. This means that it can initially hold the plugged-in plug-in connector in a pre-assembly position. When finally plugged together, for example by moving an operating element on the plug-in connector (for example, a lever element or a sliding element or the like), the stop can then be moved, such that the corresponding plug-in connector can be moved deeper into the interior space. Such a (movable) stop can, for example, also be formed to specify an end stop position that blocks or prevents further displacement of each plug-in connector along the relevant insertion direction.

According to an example embodiment of the present invention, it can be possible, for example, that a single stop is provided in the interior space. However, there can also be a plurality of stops in the interior space. For example, a separate stop can be provided in the interior space for each plug-in connector or one or more stops can be provided in the interior space for each plug-in connector.

Although the coupling fastening means can also serve as a stop or the wall of the coupling housing or its end face, these elements are often not arranged in the interior space or cannot be assigned to the interior space (end faces, etc.).

In a further development of the present invention, a base plate is provided in the interior space, wherein the base plate extends substantially along a radial direction, which runs perpendicularly to the axial direction, wherein the base plate, viewed along the axial direction, is spaced from the first opening and from the second opening in each case by at least 20% of a length of the interior space.

As a result, it is advantageously achieved that the housing is stabilized. It becomes more torsion-resistant and more stable against mechanical influences in the radial direction.

Furthermore, the base plate can advantageously serve as a stop, for example, which represents a maximum end position for the first plug-in connector and/or the second plug-in connector. Furthermore, the base plate can advantageously represent a kind of partition wall or seal between the first end and the second end. For example, it can largely form a closed surface in the interior space of the housing. For example, it can divide the interior space into a first section (from the first end to the base plate) and a second section (from the second end to the base plate). The penetration of dirt, grime or fluid media from the first section into the second section and vice versa is made more difficult or even prevented by the base plate. This can be very advantageous, for example, when using the coupling, for example, as a passage element between two differently clean spaces (for example, separating an engine compartment from a passenger compartment).

In a further development of the present invention, the base plate has at least one through-opening for the passage of a contacting section of a male contact element, in particular a pin or a contact blade, of the first plug-in connector and/or for the passage of a contacting section of a male contact element, in particular a pin or a contact blade, of the second plug-in connector.

As a result, it is advantageously achieved that an electrical connection between the male contact element and a female contact element arranged on the other side of the base plate is enabled. Furthermore, due to the through-opening, it is advantageously achieved that the male contact element is given a radial guide or that when the plug-in connector with the male contact element is inserted, it can be recognized haptically (possibly also visually from the other opening of the coupling) whether this plug-in connector has been inserted in the correct radial position, such that the male contact element actually meets the corresponding female contact element. Thus, the base plate with the through-opening serves as a kind of positioning aid.

It is understood that the base plate can have exactly one through-opening. However, it can also have multiple through-openings. For example, it has a through-opening for each male contact element.

For example, it can advantageously be provided that the through-opening has a diameter that is only slightly larger (for example, at most 20% larger or at most 10% larger) than a contacting section of the male contact element, wherein the contacting section passes through the through-opening and contacts the corresponding female contact element on the other side of the base plate.

Furthermore, it can be advantageously provided according to the present invention, for example, that the through-opening has an insertion chamfer or an insertion funnel on the side facing the male contact element, such that the contacting section is “captured” when the plug-in connector is inserted into the first opening and the contacting section is then guided into the through-opening by means of the insertion chamfer or the insertion funnel. In this way, damage-free, simple and secure contacting between the male contact element and the corresponding female contact element can be achieved even if the plug-in connector is slightly tilted radially. It is also possible that the through-opening has an insertion chamfer on both sides of the base plate. In this way, the coupling can be used advantageously for any plug-in direction of male contact elements. The constriction of the through-opening between two such insertion chamfers advantageously achieves a radial positioning of an inserted male contact element.

Furthermore, for example, a seal can be advantageously provided in the through-opening or on the base plate, i.e. upstream or downstream of the through-opening when viewed in the axial direction. In this way, the sealing effect of the base plate between the first section and the second section is advantageously further improved.

It is understood that each of the two plug-in connectors can have at least one male contact element that can be connected to a corresponding female contact element of the relevant other plug-in connector. However, it is also possible that, for example, only the second plug-in connector has male contact elements and the first plug-in connector only has female contact elements.

In a further development of the present invention, a first seal is provided at the first end, which seal is designed to seal the interior space from the first opening against an external environment of the coupling in interaction with the first plug-in connector.

As a result, it is advantageously achieved that the electrical contacts are protected from dirt, grime and/or fluid media being able to penetrate from the exterior space into the interior space through the first opening. As a result, penetration up to the second opening is also prevented. This can be particularly advantageous, for example, if the first opening is exposed to an environment that is not particularly clean or dry. Such an environment can be, for example, the engine compartment of a motor vehicle.

It is understood that, in an equivalent manner, the first seal can alternatively or additionally also be arranged on the first plug-in connector and is then inserted together with the first plug-in connector into the interior space of the coupling or the housing, and sealing is ensured in this way.

According to an example embodiment of the present invention, alternatively or additionally, a second seal is provided at the second end, which seal is designed to seal the interior space from the second opening against the external environment of the coupling in interaction with the second plug-in connector.

As a result, it is advantageously achieved that the electrical contacts are protected from dirt, grime and/or fluid media being able to penetrate from the exterior space into the interior space through the second opening. As a result, penetration up to the first opening is also prevented. This can be particularly advantageous, for example, if the second opening is exposed to an environment that is not particularly clean or dry. Such an environment can be, for example, the engine compartment of a motor vehicle.

It is understood that, in an equivalent manner, the second seal can alternatively or additionally also be arranged on the second plug-in connector and is then inserted together with the second plug-in connector into the interior space of the coupling or the housing, and sealing is ensured in this way.

In a further development of the present invention, at least one fastening apparatus is provided on the housing for fastening the coupling to another element, in particular to or in a wall.

As a result, the coupling can advantageously be stabilized—an electrical connection created in its interior space by inserting the first plug-in connector and the second plug-in connector and/or the captive coupling of the plug-in connectors on the coupling are advantageously protected against unintentional movements, the penetration of dirt, grime and moisture (for example, if the coupling were to lie on the floor or fall to the floor) by fastening the coupling to an external element. Furthermore, the provision of the fastening apparatus advantageously provides a defined element by means of which the coupling can be fastened. As a result, improvised assembly of the coupling on another element, which would damage or conceal one of the coupling fastening means, for example, can be advantageously avoided.

In a further development of the present invention, a first section of the interior space, in which the first plug-in connector can be received, has a first cross-section, wherein a second section of the interior space, in which the second plug-in connector can be received, has a second cross-section, wherein the first cross-section and the second cross-section have an identical shape or have shapes that are mirror-symmetrical relative to one another.

As a result, it is advantageously achieved that the coupling is particularly simple and cost-effective to produce. Furthermore, as a result, the coupling can advantageously be used from both openings at the same time. Incorrect alignment, for example in the case of automated coupling of the plug-in connectors or assembly under poor visibility conditions (for example, in an engine compartment), can thus be avoided. The quality of assembly is advantageously increased. The time required for assembly is advantageously reduced. In this way, two identical connector housings can also be advantageously used for the first plug-in connector and the second plug-in connector. As a result, considerable costs can be saved.

According to a second aspect of the present invention, a plug-in connector arrangement is proposed.

The plug-in connector arrangement has a first plug-in connector, a second plug-in connector and a coupling as described above. The first plug-in connector has a first plug-in connector housing having a first contact chamber and a female contact element arranged in the first contact chamber.

According to an example embodiment of the present invention, the first plug-in connector has a first fastening means. This can simply be designed or formed as a lever element and/or a sliding element, for example. The second plug-in connector has a second plug-in connector housing having a second contact chamber and a male contact element arranged in the second contact chamber. The second plug-in connector has a second fastening means. This can simply be designed or formed as a further lever element and/or a further sliding element, for example. The first plug-in connector is inserted into the interior space through the first opening and is captively coupled to the coupling by means of a coupling between the first fastening means and the first coupling fastening means. The second plug-in connector is inserted into the interior space through the second opening and is captively coupled to the coupling by means of a coupling between the second fastening means and the second coupling fastening means. The male contact element of the second plug-in connector is electrically connected to the female contact element of the first plug-in connector. It can be plugged together with the female contact element, for example.

As a result, it is advantageously achieved that a simple and cost-effective apparatus for designing, for example, extension lines for cable harnesses or cable harness plugs is provided. For example, such an extension cable can have two plug-in connectors of the same type at both ends, such that standard parts can be used cost-effectively. Advantageously, the use of plug-in connector housings of the same type can be enabled or it is possible to cost-effectively and captively connect two plug-in connectors, which could not be coupled to one another due to their geometry, to one another electrically and mechanically. In this way, the cost-intensive manufacturing of corresponding mating plug-in connector housings for the first plug-in connector and/or the second plug-in connector can advantageously be made superfluous. At the same time, the direct electrical contacting between the first plug-in connector and the second plug-in connector (or its female contact element with the male contact element) advantageously prevents additional contact points from being formed, for example in an adapter piece with its own electrical conductors. Thus, the plug-in connector arrangement saves space and offers secure and reliable, low-resistance electrical contacting. At the same time, it is thus formed to be mechanically captive and therefore robust, even if two plug-in connector housings that are normally mechanically incompatible or cannot be directly captively coupled to one another are part of the plug-in connector arrangement.

The female contact element can be formed as a socket contact element, for example. The male contact element can be formed as a contact pin or a contact blade, for example. Preferably, the male contact element is complementary to the female contact element. An electrical connection can be established between the male contact element and the female contact element, for example by inserting or sliding the male contact element into or onto the female contact element.

It is understood that exactly one first contact chamber is provided in the first plug-in connector housing. However, multiple first contact chambers can also be provided.

It is further understood that the first plug-in connector can have exactly one female contact element (and no other contact element at all). However, it can also have multiple female contact elements, which are arranged in corresponding first contact chambers, for example. Furthermore, it is possible that the first plug-in connector additionally has one or more male contact elements. These can also be assembled or arranged in corresponding first contact chambers, for example.

It is also understood that the first plug-in connector can have exactly one first fastening element or fastening means. However, it can also be provided that it has multiple first fastening means. These can all have the same design or be formed differently. For example, a lever element can interact with a sliding element.

The considerations presented above regarding the type and number of first contact chamber, female contact element and/or first fastening means(s) apply analogously to the second plug-in connector (here, for second contact chamber(s), male contact element and the possibility that at least one female contact element is also provided as well as for second fastening means).

In a further development of the present invention, the first plug-in connector housing is mirror-symmetrical, in particular along a first longitudinal axis.

As a result, the use of the first plug-in connector housing is also advantageously enabled for the second plug-in connector (thus as a second plug-in connector housing). For the second plug-in connector, it merely needs to be fitted with contact elements that are formed to be complementary to the contact element of the first plug-in connector or the contact elements of the first plug-in connector. The use of a mirror-symmetrical housing also enables the contact elements to meet precisely if the two plug-in connectors are placed on top of one another with their plug-in connector faces, since the mirror symmetry prevents chirality.

Alternatively or additionally, the second plug-in connector housing is mirror-symmetrical, in particular along a second longitudinal axis.

In a further development of the present invention, the first plug-in connector housing and the second plug-in connector housing are designed as identical parts.

As a result, a particularly cost-effective connector arrangement is advantageously created. This is because, for example, the first plug-in connector housing, which is produced in large quantities, can be used without the need to purchase a separate tool for its production. The second plug-in connector housing merely needs to be fitted with contact elements in the contact chamber or contact chambers that are complementary to those of the first plug-in connector.

Alternatively, according to an example embodiment of the present invention, the first plug-in connector housing and the second plug-in connector housing are designed to be mirror-symmetrical relative to one another.

As a result, it is advantageously achieved that the two plug-in connector housings fit together when they meet inside the coupling.

### BRIEF DESCRIPTION OF THE DRAWINGS

Further features and advantages of the present invention will become apparent to a person skilled in the art from the following description of exemplary embodiments, which, however, are not to be interpreted as limiting the present invention, with reference to the figures.

FIG. 1 shows a schematic longitudinal section of a coupling with a coupled first plug-in connector and a second plug-in connector, which is in a state immediately prior to coupling with the coupling, according to an example embodiment of the present invention.

FIG. 2 shows a schematic perspective view of the coupling from FIG. 1 without a plug-in connector, according to an example embodiment of the present invention.

### DETAILED DESCRIPTION OF EXAMPLE EMBODIMENTS

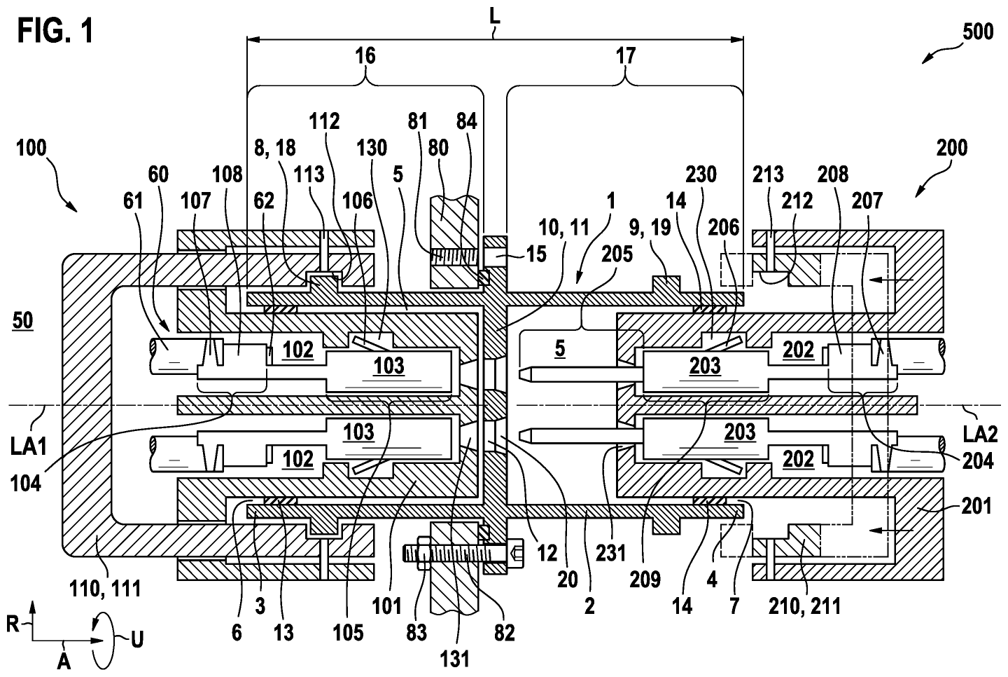

FIG. 1 shows a schematic longitudinal section of a coupling 1 that has a coupled first plug-in connector 100 and a second plug-in connector 200, which is in a state immediately prior to coupling with the coupling 1.

In the fully plugged-together state, in which the first plug-in connector 100 and the second plug-in connector 200 are captively coupled to the coupling 1, a plug-in connector arrangement 500 is formed.

The coupling 1 is designed for receiving two plug-in connectors 100, 200 which face one another, make direct electrical contact with one another and each have at least one fastening means (i.e., fastener) 110, 210 for fastening to a mating plug-in connector (not shown here), for example a male connector of a control device or contact pins of a sensor.

The coupling 1 has a housing 2 which extends along an axial direction A and has a first end 3 and a second end 4 averted from said first end. Furthermore, it has an interior space 5. This interior space 5 can, for example, be an interior space of the housing 2 as shown here.

A radial direction R extends perpendicularly to the axial direction A and a direction of rotation U extends around the axial direction A.

A first opening 6 is provided at the first end 3 of the housing 2 for inserting the first plug-in connector 100, wherein the first plug-in connector has the first fastening means 110. A second opening 7 is provided at the second end 4 of the housing 2 for inserting a second plug-in connector 200, which has the second fastening means 210. A first coupling fastening means 8 is arranged at the first end 3, which is designed to interact with the first fastening means 110 of the first plug-in connector 100 in such a way that the first plug-in connector 100 can be captively coupled to the coupling 1, wherein a second coupling fastening means 9 is arranged at the second end 4, which is designed to interact with the second fastening means 210 of the second plug-in connector 200 in such a way that the second plug-in connector 200 can be captively coupled to the coupling 1.

In the fully plugged-together state (not shown here), a plug-in connector arrangement 500 is formed, as already described above. This has the first plug-in connector 100, the second plug-in connector 200 and the coupling 1.

The first plug-in connector 100 has a first plug-in connector housing 101 with two first contact chambers 102 visible here by way of example in the longitudinal section of FIG. 1. Both first contact chambers 102 are in each case fitted with a female contact element 103. The first plug-in connector 100 has a first fastening means 110, which is formed by way of example here as a lever element 111.

The second plug-in connector 200 has a second plug-in connector housing 201 with, by way of example, two second contact chambers 202 visible here in the longitudinal section of FIG. 1. Both second contact chambers 202 are in each case fitted with a male contact element 203. The second plug-in connector 200 has a second fastening means 210, which is formed by way of example here as a further lever element 211.

The first plug-in connector 100 is inserted into the interior space 5 through the first opening 6 and is captively coupled to the coupling 1 by means of a coupling between the lever element 111 and the two bolts 18 shown here as first coupling fastening means 8.

The second plug-in connector 200 is inserted into the interior space 5 through the second opening 7 and can be captively coupled to the coupling 1 by means of a coupling between the further lever element 211 and the two further bolts 19 shown here as second coupling fastening means 9. In FIG. 1, the coupling of the second plug-in connector 200 has not yet been finalized, but the fully coupled state would, here by way of example, look similar to the state of the first plug-in connector 100 on the left-hand side of FIG. 1.

In the fully assembled state to the plug-in connector arrangement 500, the two male contact elements 203 of the second plug-in connector 200 are directly electrically connected to the two female contact elements 103 of the first plug-in connector 100. The male contact elements 203 are then inserted into or plugged together with the female contact elements 103.

Here, by way of example, the female contact elements 103 have a first crimping section 104 averted from the interior space 5, in which section a first insulation crimp 107 and a first conductor crimp 108 are arranged. In an analogous way, the male contact elements 203 each have a second crimping section 204 averted from the interior space 5, in which section a second insulation crimp 208 and a second conductor crimp 208 are arranged. In the first crimping section 104 or in the second crimping section 204, a cable 60 is fastened to each female contact element 103 or male contact element 203 and electrically connected to the relevant contact element 103, 203. Each cable 60 has, by way of example, an insulation 61 and an electrical conductor 62. The insulation 61 is fastened in each case by the insulation crimps 107, 207, the conductor 62 in each case by the conductor crimps 108, 208. In principle, other fastening methods such as welding, soldering, bonding, cutting/clamping, etc. are also possible.

The female contact elements 103, which can be formed as socket contact elements, for example, furthermore comprise here, by way of example, a female contacting section 105 facing the interior space 5, which can be formed as a type of contact box. Inside the female contacting section 105, contact slats not shown here (at least one contact slat each) can be provided, for example. An elastically reversibly deflectable first latching lance 106 projecting outwardly at an angle, which can also be referred to as a primary latching lance or primary locking lance, is arranged in the female contacting section 105. Each first latching lance 106 can engage behind a first undercut 130 of the first plug-in connector housing 101 if the female contact element 103 has been fitted into its first contact chamber 102.

The male contact elements 203, which can be formed as pin contacts or contact blades, for example, have, here by way of example, male contacting section 205 facing the interior space 5. In this embodiment, they furthermore have-merely by way of example—a box section 209, which is located in the axial direction A between the contacting section 205 and the crimping section 204. An elastically reversibly deflectable second latching lance 206 projecting outwardly at an angle, which can also be referred to as a primary latching lance or primary locking lance, is arranged in the box section 209. Each second latching lance 206 can engage behind a second undercut 230 of the second plug-in connector housing 201, if the male contact element 203 has been fitted into its second contact chamber 202.

It is possible, by way of example, that the male contact elements 203 are actually also originally formed as female contact elements. With the aid of an adapter pin inserted into the front opening, which acts like a contact blade or pin contact, a male contact element 203 can then be produced in a simple and cost-effective manner from the female contact elements produced in large quantities. In this way, the use of common parts is further increased, which further reduces the costs for the production of male contact elements to be produced separately and thus the costs for the plug-in connector arrangement 500. The male contacting section 205 would then be the part of such an adapter pin protruding from the female contacting element originally formed as a socket contact element, for example. The adapter pin can, for example, have a contact body which extends along a longitudinal axis of the adapter pin with a first adapter pin end facing the (original) female contact element and a second adapter pin end averted from said first end, along with at least one means for captive, in particular non-destructive and releasable, coupling of the adapter pin to the (original) female contact element. For example, the adapter pin can be clamped in the (original) female contact element by a pressing element arranged at the end of the first adapter pin, for example by pressing the contact slat(s) flat. Alternatively or additionally, the adapter pin can have latching lances (not shown here) that grip around a front end (contact mouth) of the (original) female contact element. This at least one latching lance can then, for example, latch into a recess in a wall of the (original) female contact element and thus captively couple the adapter pin to the (original) female contact element, thereby converting it into a male contact element.

In the first plug-in connector housing 101, in each case a first housing through-opening 131 is formed for the two contact chambers 102 shown here, through which the contacting section 205 of the male contact element 203 of the second plug-in connector 200 can electrically make contact with the relevant female contact element 103. The first housing through-openings 131 can, by way of example, be provided with an insertion funnel on the side facing the male contact element 203.

In the second plug-in connector 200, each of the contact chambers 202 shown here also has a second housing through-opening 231, through which the male contacting section 205 can protrude outwardly from the contact chamber 202.

The first lever element 111 is connected in a rotatably mounted manner to the first plug-in connector housing 101 by means of two first lever shafts 113. The first lever element 111 has a first sliding track 112 on each side facing the first plug-in connector housing 101, into which in each case one of the bolts 18 can engage. By rotating the first lever element 111, the first plug-in connector 100 can then be pulled into the interior space 5 of the coupling 1. In the state shown on the left-hand side in FIG. 1, the first lever element 111 is displaced to its end position and the first plug-in connector is thus captively coupled to the coupling 1. The first plug-in connector 100 can thus be fastened to the coupling 1 captively, but at the same time in a non-destructive, releasable manner. Thus, the first end 3 of the coupling 1 acts in the manner of a plug-in collar of a mating plug-in connector complementary to the first plug-in connector 100.

The further lever element 211 is connected in a rotatably mounted manner to the second plug-in connector housing 201 by means of two second lever shafts 213. The further lever element 211 has a second sliding track 212 on each side facing the second plug-in connector housing 201, into which in each case one of the further bolts 19 can engage. By rotating the additional lever element 211, the second plug-in connector 200 can then be pulled into the interior space 5 of the coupling 1. In the state shown on the right-hand side in FIG. 1, the second lever element 211 can still be seen in its initial position. Since, here, the further lever element 211 partially protrudes from the drawing plane or sectional plane, this part of the further lever element 211 is shown dashed, as is a front part of the further lever element 211 delimiting the sliding track. When the second plug-in connector is further inserted into the interior space 5, the further bolts 19 will then engage in the second sliding tracks 212. When the further lever element 211 is rotated, the second plug-in connector 200 is then pulled into the interior space 5 by the interaction of the further bolts 19 with the further or second sliding tracks 212, such that in the end position of the further lever element 211, the male contact elements 203 make direct electrical contact with the female contact elements 103. The second plug-in connector 200 is then fastened to the coupling 1 captively, but at the same time in a non-destructive, releasable manner. The second end 4 of the coupling 1 thus acts in the manner of a plug-in collar of a mating plug-in connector complementary to the second plug-in connector 100.

In this exemplary embodiment, the housing 2 of the coupling 1 is torsionally stiff and/or rigid. For example, it can be injection-molded from an (electrically insulating) thermoplastic or thermosetting plastics material. However, it can also be made of a metal sheet (or another electrically conductive material) and thus have an electrical shielding effect. The wall thickness of the housing can, for example, be between 0.5 mm and 10 mm, preferably between 1 mm and 4 mm. Furthermore, it is possible that the housing 2 is made partly of (electrically insulating) plastics material and partly of metal. In this way, electrical insulation can be provided in the region of the direct electrical connection of the first and second plug-in connector 100, 200 and at the same time a shielding of the environment can be achieved by the metal components (for example, an outer metal sheet) or radiation from the environment to the electrical contact point can be shielded.

The first coupling fastening element 8 is here merely by way of example formed—as described above—as a bolt 18 or pin projecting radially outwardly, wherein in the longitudinal section shown, one bolt 18 each is shown on the upper and lower outer wall of the housing 2 viewed in the radial direction R. The second coupling fastening means 9 is here merely by way of example formed—as described above—as a further bolt 19 or further pin projecting radially outwardly. As with the first coupling fastening element or coupling fastening means 8, two further bolts 19 are also shown on the upper and the lower outer wall of the housing 2 of the second coupling fastening element or coupling fastening means 9. It is understood that the type of coupling fastening means 8, 9 along with the number thereof may be different in other exemplary embodiments than presented here by way of example.

The bolts 18 are designed to interact with a first fastening means 110 of the first plug-in connector 100, formed here as a lever element 111 by way of example, for captive coupling between the coupling 1 and the first plug-in connector 100, as already described above. In the same way, the further bolts 19 are designed for captive coupling of the second plug-in connector 200 to the coupling 1 by means of the second lever element 211.

In addition, a force transmission can be provided at the first lever element 111 and/or at the second lever element 211, such that the operating forces are reduced when the first plug-in connector 100 is plugged together with the coupling 1 or with the second plug-in connector 200. In principle, for example, sliding elements or the like are also possible as first and/or second fastening means 110, 210.

The bolts 18 and the further bolts 19 are designed here by way of example to form a positive and/or non-positive and/or frictional connection to the first lever element 111 or the second lever element 211.

A stop 10 is provided in the interior space 5 of the housing 2, wherein the stop 10 is designed to block a displacement of the first plug-in connector 100 and/or the second plug-in connector 200 along their respective plug-in directions (in FIG. 1: first plug-in connector 100 from left to right, second plug-in connector 200 from right to left, i.e. parallel to the axial direction A in each case) beyond the stop 10.

A base plate 11 is provided in the interior space 5, wherein the base plate 11 extends substantially along the radial direction R. Viewed along the axial direction A, the base plate 11 is spaced from the first opening 6 and from the second opening 7 by at least 20% of a length L of the interior space 5.

The base plate 11 divides the coupling 1 into a first section 16 and a second section 17. Here, by way of example, it also serves as a stop 10 for the two plug-in connectors 100, 200. In other embodiments, however, the (at least one) stop 10 can also be formed separately from the base plate 11. The base plate 11 can also be dispensed with.

The base plate 11 has two through-openings 12 visible here. These are provided for passing through the contacting sections 205 of the male contact elements 203, which are assigned here to the second plug-in connector 200. The through-openings 12 each have an insertion chamfer 20 or an insertion funnel facing the male contacting sections 205. An insertion chamfer 20 can also be provided on both sides of the through-openings 12. As a result, a damage-free and simple passage of the contacting sections 205 through the base plate 11 is achieved, even if the second plug-in connector 200 is assembled in a slightly radially incorrect position in the interior space 5 of the coupling 1. Together with the base plate, the through-opening 12 also achieves a kind of centering or positioning of the male contacting sections relative to the corresponding female contact elements 103, such that the connection of the two plug-in connectors 100, 200 is ensured simply and without damage. The base plate can, for example, have a thickness of between 0.5 mm and 10 mm, preferably between 0.7 mm and 4 mm.

A first seal 13 is provided at the first end 3 of the coupling 1, which here extends around an inner wall of the housing 2 along the direction of rotation U. It can also be arranged on the first plug-in connector 100. In interaction with the first plug-in connector 100, it is designed to seal the interior space 5 from the first opening 6 against an external environment 50 of the coupling 1. Furthermore, a second seal 14 is provided at the second end 7. In principle, this second seal 14 can also be arranged on the second plug-in connector 200. It also extends around the inner wall of the housing 2 along the circumferential direction U. The second seal 14 is designed to seal the interior space 5 from the second opening 7 against the external environment 50 of the coupling 1 in interaction with the second plug-in connector 200. As a result the interior space and, in particular, the electrical contacts inside are protected against moisture, dirt and grime.

A fastening apparatus 15 is also provided on the housing 2 of the coupling 1, here in the form of a collar that has through-holes, for example for inserting screws 82. The fastening apparatus 15 is formed for fastening the coupling 1 to another element, here by way of example to a wall 80. For this purpose, the screw 82 is inserted through the through-hole, further through a wall through-hole or a wall fastening opening 81 and fixed, here by way of example, with a nut 83 against the rear side of the wall 80 (here, the left side of the wall 80). Viewed in the axial direction A, a sealing element 84, for example, a cord seal or an O-ring, is arranged between the collar or the fastening apparatus 15 and the wall 80 in this exemplary embodiment. In this way, a dirty and/or damp environment (for example, an engine compartment) located on the left-hand side of the wall 80, for example, is sealed in a dirt-tight and fluid-tight manner against a clean and/or dry environment (for example, a passenger compartment) located on the right-hand side of the wall 80.

In the illustrated exemplary embodiment, a first section 16 of the interior space 5, in which the first plug-in connector 100 can be received (or is received), has a first cross-section Q1, and the second section 17 of the interior space 5, in which the second plug-in connector 200 can be received (or is received), has a second cross-section Q2. The first cross-section Q1 and the second cross-section Q2 have an identical shape or at least a mirror-symmetrical shape relative to one another.

In the merely exemplary embodiment of FIG. 1, it is assumed that the first plug-in connector housing 101 is mirror-symmetrical, in particular along a first longitudinal axis LA1. Furthermore, it is assumed that the second plug-in connector housing 200 is mirror-symmetrical, in particular along a second longitudinal axis LA2. The two longitudinal axes LA1, LA2 are parallel to the axial direction A.

In the exemplary embodiment of FIG. 1, it is furthermore assumed by way of example (although only a longitudinal section is shown) that the first plug-in connector housing 100 and the second plug-in connector housing 200 are designed as identical parts. Here, by way of example, the first plug-in connector housing 100 and the second plug-in connector housing 200 are furthermore designed to be mirror-symmetrical relative to one another.

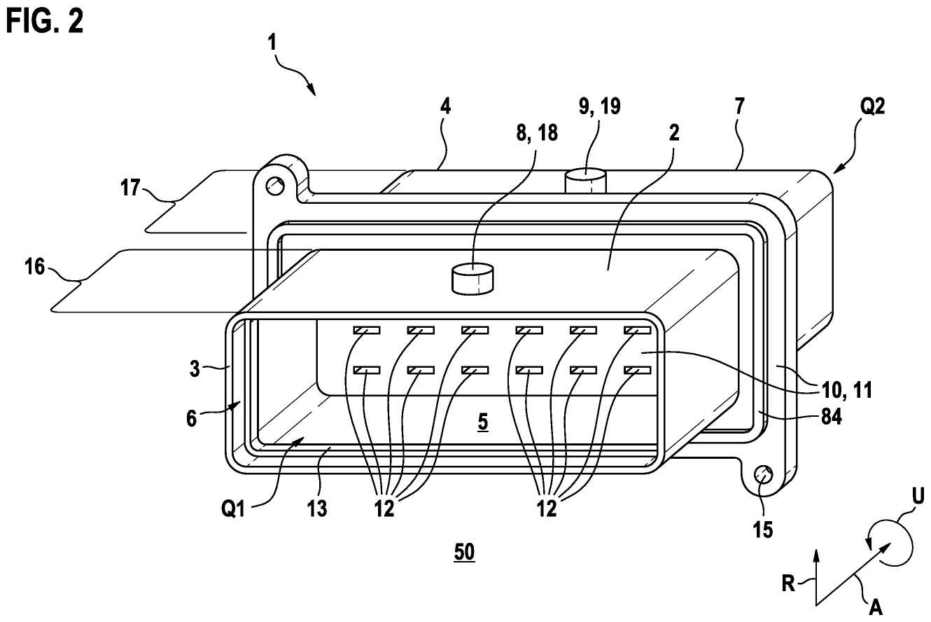

FIG. 2 shows a schematic perspective view of the coupling from FIG. 1 without plug-in connectors 100, 200. The base plate 11 with its through-openings 12 is clearly visible, as is the first seal 13.

The first cross-section Q1 is recognizably equal to the second cross-section Q2, such that it does not matter from which end 3, 4 the first plug-in connector 100 or the second plug-in connector 200 is plugged in. This is all the more the case as the coupling fastening means 8, 9, 18, 19 and the fastening apparatus 15 are also mirror-symmetrical or rotationally symmetrical.

The coupling 1 or the plug-in connector arrangement 500 can be used, for example, for plug-in connectors with at least one contact chamber or at least one receptacle for receiving a female contact element or the contact element arrangement. In particular, it can be used for miniaturized contact elements (sheet thicknesses of significantly less than 1 mm) or high-pole plug-in connectors or cable harness plug-in connectors. It is particularly advantageous for use in cable harness plug-in connectors for control devices and/or in cable harness plug-in connectors for motor vehicles.

1-13. (canceled)

14. A coupling configured to receive two plug-in connectors which face one another, make direct electrical contact with one another and each have at least one fastener configured to fasten to a mating plug-in connector, the coupling comprising:
a sleeve-like housing which extends along an axial direction and has a first end, a second end facing away from the first end, and an interior space;
wherein a first opening for inserting a first plug-in connector having a first fastener is provided at the first end,
wherein a second opening for inserting a second plug-in connector having a second fastener is provided at the second end,
wherein a first coupling fastener is arranged at the first end and is configured to interact with the first fastener of the first plug-in connector in such a way that the first plug-in connector can be captively coupled to the coupling,
wherein a second coupling fastener is arranged at the second end and is configured to interact with the second fastener of the second plug-in connector in such a way that the second plug-in connector can be captively coupled to the coupling.

15. The coupling according to claim 14, wherein the housing is torsionally stiff and/or rigid.

16. The coupling according to claim 14, wherein: (i) the first coupling fastener is configured to form a positive and/or non-positive and/or frictional connection to the first fastener, and/or (ii) the second coupling fastener is configured to form a positive and/or non-positive and/or frictional connection to the second fastener.

17. The coupling according to claim 14, wherein:
(i) the first coupling fastener is formed as an outwardly or inwardly projecting bolt or projection or pin or as a toothed rack, and the bolt or projection or pin or the toothed rack is configured to interact with a first fastener formed as a lever element or as a sliding element for captive coupling between the coupling and the first plug-in connector, and/or
(ii) wherein the second coupling fastener is formed as an outwardly or inwardly projecting further bolt or as a further projection or further pin or as a further toothed rack, and the further bolt or further projection or further pin or the further toothed rack is configured to interact with a second fastener formed as a further lever element or further sliding element for captive coupling between the coupling and the second plug-in connector.

18. The coupling according to claim 14, wherein a stop is provided in the interior space of the housing, and the stop is configured to block a displacement of the first plug-in connector and/or the second plug-in connector along its respective plug-in directions beyond the stop.

19. The coupling according to claim 14, wherein a base plate is provided in the interior space, the base plate extending substantially along a radial direction, which runs perpendicularly to an axial direction, and wherein the base plate, viewed along the axial direction, is spaced from the first opening and from the second opening in each case by at least 20% of a length of the interior space.

20. The coupling according to claim 14, wherein: the base plate has at least one through-opening for: (i) passage of a contacting section of a male contact element including a pin or a contact blade, of the first plug-in connector, and/or (ii) for passage of a contacting section of a male contact element including a pin or a contact blade, of the second plug-in connector.

21. The coupling according to claim 14, wherein:
(i) a first seal is provided at the first end, which is configured to, in interaction with the first plug-in connector, seal the interior space from the first opening against an external environment of the coupling, and/or
(ii) a second seal is provided at the second end, which is configured to, in interaction with the second plug-in connector, seal the interior space from the second opening against the external environment of the coupling.

22. The coupling according to claim 14, wherein at least one fastening apparatus is provided on the housing configured to faste the coupling to or in a wall.

23. The coupling according to claim 14, wherein a first section of the interior space, in which the first plug-in connector can be received, has a first cross-section, wherein a second section of the interior space, in which the second plug-in connector can be received, has a second cross-section, and wherein the first cross-section and the second cross-section have an identical shape or have shapes that are mirror-symmetrical relative to one another.

24. A plug-in connector arrangement, comprising:
a first plug-in connector;
a second plug-in connector; and
a coupling including:
a sleeve-like housing which extends along an axial direction and has a first end, a second end facing away from the first end, and an interior space;
wherein a first opening for inserting the first plug-in connector having a first fastener is provided at the first end,
wherein a second opening for inserting the second plug-in connector having a second fastener is provided at the second end,
wherein a first coupling fastener is arranged at the first end and is configured to interact with the first fastener of the first plug-in connector in such a way that the first plug-in connector can be captively coupled to the coupling,
wherein a second coupling fastener is arranged at the second end and is configured to interact with the second fastener of the second plug-in connector in such a way that the second plug-in connector can be captively coupled to the coupling,
wherein the first plug-in connector has a first plug-in connector housing having a first contact chamber and a female contact element arranged in the first contact chamber,
wherein the first fastener of the first plug-in connector includes a lever element and/or a sliding element,
wherein the second plug-in connector has a second plug-in connector housing having a second contact chamber and a male contact element arranged in the second contact chamber,
wherein the second fastener of the second plug-in connector includes a further lever element and/or a further sliding element,
wherein the first plug-in connector is inserted into the interior space through the first opening and is captively coupled to the coupling by a coupling between the first fastener and the first coupling fastener,
wherein the second plug-in connector is inserted into the interior space through the second opening and is captively coupled to the coupling by a coupling between the second fastener and the second coupling fastener, and
wherein the male contact element of the second plug-in connector is electrically connected to the female contact element of the first plug-in connector, and plugged together.

25. The plug-in connector arrangement according to claim 24, wherein:
the first plug-in connector housing is mirror-symmetrical, along a first longitudinal axis, and/or
the second plug-in connector housing is mirror-symmetrical, along a second longitudinal axis.

26. The plug-in connector arrangement according to claim 24, wherein:
(i) the first plug-in connector housing and the second plug-in connector housing are identical parts, or
(ii) the first plug-in connector housing and the second plug-in connector housing are mirror-symmetrical relative to one another.
